(19) United States
(12) Patent Application Publication
(10) Pub. No.: US 2008/0082537 A1
(43) Pub. Date: Apr. 3, 2008

(54) Method and system for collecting sales prospect information

(76) Inventors: Ayman Ahmed, Yorktown, NY (US); Zhe Huang, Fair Lawn, NJ (US)

Correspondence Address: Douglas Wyatt, 99 Park Avenue, New York, NY, 10016, US

(21) Appl. No.: 11/540,295

(22) Filed: Sep. 29, 2006

(51) Int. Cl. G06F 17/30

(52) U.S. Cl. 707/9

(57) ABSTRACT

A device and method for collecting point of contact information for individuals, in which personal identification information associated with an individual is obtained and stored, and contemporaneous observation data associated with the individual, such as an audio or video information is captured, stored and automatically associated with personal identification information of the individual.

### FIELD OF THE INVENTION

The invention relates to data collection techniques in the field of exhibition industries. The invention is especially useful for a user to collect information from individuals, such as during face-to-face meetings with sales prospects at trade exhibitions. The invention provides a method and device for capturing and organizing information obtained during contact with sales leads.

### BACKGROUND OF THE INVENTION

The collection of sales lead information is an important aspect in the field of exhibition industries. At exhibitions, exhibition participants seek to collect information associated with sales prospects especially at a point of contact meetings with the sales prospects. Point of contact meetings include face-to-face meetings, during which exhibition participants seek to obtain information about the sales prospect, such as name and contact information for the sales prospect. To facilitate the collection of information regarding sales prospects, devices for collecting personal identification information from exhibition badges have been used.

However, exhibition participants may additionally desire to retain additional information about a sales prospect, such as notes regarding a conversation with the sales prospect, notes regarding follow-up activity with the sales prospect, among other things. In addition, where personal information cannot be readily collected by means of devices, such as identification badges, the device permits an individual to record personal identification information such as by recording a voice note, which information can later be used to complete data records comprising personal identification of an individual, such as a sales prospect.

The time for obtaining and retaining additional information from a sales prospect is often limited. Accordingly, the invention provides for an improved method and device for collecting sales prospect information.

### OBJECTS OF THE INVENTION

It is an object of the invention to provide for an improved method and device for collecting personal information from sales prospects and for facilitating the collection of other information associated with a sales prospect at a point of contact.

It is a further object of the invention to provide for an improved method and device for facilitating review, organization, analysis, and qualification of point of contact information.

### SUMMARY OF THE INVENTION

The invention relates to data collection techniques and contact collection devices to facilitate the collection information from individuals, such as sales prospects, at a point of contact. The invention is especially useful for a user to collect information from individuals during face-to-face meetings, such as contacts made during trade shows in the exhibition industries. Specifically, the invention provides for the retrieval of personal information from business prospects, and facilitates the collection of other information associated with an individual at a point of contact. In addition, the invention provides for a technique for facilitating review, organization, analysis, and qualification of individual information.

In one embodiment, a hand-held device, such as a PDA, is provided that can capture sales lead information. The hand-held device has the ability to read encoded data from devices such as a barcode, magnetic stripe, RFID tag, or an integrated circuit chip. Leads are individual contacts for which a decision to provide follow up activity can be made by a user of the device based upon individual identification information and other information that is collected and associated with a lead at a point of contact. A user of the device can collect associated information contemporaneously with the individual identification information collected at the point of contact.

For example, at the time of contact with a lead when personal information may be obtained, a user of the contact collection device can input voice and/or video information (such as a photo image) associated with the lead. This is especially useful in the trade show scenario, where contact with sales leads occur rapidly and the ability to capture information through voice notes permits a user to focus attention on the lead rather than become distracted by other slower data collection methods, such as keying information by means of a keypad. In addition, by enabling the use of voice notes associated with a lead's personal information, the invention permits a user to maintain visual contact to concentrate on the substance of a conversation or occurrences at the point of contact, all while storing information related to a lead which could otherwise be lost. Accordingly, the invention provides a solution that is much more than providing an additional means of inputting data. Providing the automatic capture of observation data, such as a voice note, permits a user with the ability to perform the technical tasks associated with information capture while engaging in social interaction. In addition, providing for the automatic association of recorded observation data with personal information of a sales prospect facilitates an exhibition participant's need to collect sales lead information. Thus, a device that provides for the collection of observation data at the same time as personal information is obtained, provides for a convenient, faster and easier method to multitask the collection and storage of information during a point of contact.

When observation data such as voice notes are recorded, a device according to the invention automatically associates the observation data with the general record of a lead's personal information stored in a memory of the device. For example, once an individual lead's information is collected, a device according to the invention can prompt a user to store a voice memo associated with the lead information. Alternatively, a device according to the invention can be programmed to enable a user to input and store audio information, such as a voice note, or append/replace existing audio information upon demand by the user. Accordingly, a device can include a prompt override to permit the user to choose between automatic audio information input prompted by the device or input of audio information upon a user's command.

In addition, where personal information cannot be readily collected by means of devices, such as identification badges, the device permits an individual to record personal identification information such as by recording a voice note, which information can later be used to complete data records comprising personal identification of an individual, such as a sales prospect. Thus, an alternative embodiment of the invention provides a user to associate observation data, such as a voice note, with an incomplete data record. Personal identification information can be included in the voice note for later inclusion in fields of the record associated with the voice note.

A method and device according to the invention can provide a user with the option to search and/or navigate among records stored in a device, and to select a stored record for display. In addition, a method and device according to the invention can provide a user with the capability to review recorded audio voice notes or other observation data. For example, when a user navigates to a record, observation data such as voice notes can be played back in a predetermined sequence, such as by order of recordation. Alternatively or in addition, a user can rearrange the precedence of lead records and thereby modify the order of playback of voice notes. Thus, a user can play back voice notes associated with any lead he likes to review in a manner according to preference.

A user can partially review voice notes and skip forward to subsequent notes. While a voice note is previewed, a user can be shown the personal information collected for the lead associated with the voice note on the screen of the device. Thus, it is possible for a user to quickly locate and preview content of a number of contacts based on recorded observation data.

Another aspect of the invention is the ability to capture additional data through video capture by a camera provided with the device, and thus capture still or moving images. This is especially useful in the trade show scenario where contact with sales leads occur rapidly. The capacity of a device to contemporaneously capture video data permits a user to focus attention on the lead. Storage of video data can be accomplished in a manner similar to storage of voice and audio data, such as in a dedicated folder and utilizing a predetermined naming technique. A user can also preview previously recorded video images for quick retrieval. Thumbnails of video data, such as videos and photographs, can be displayed on a screen of a device. Thus, a user can quickly locate and preview content of a number of contacts, and view information associated with a lead.

Similarly, an aspect of the invention provides a user with the ability to readily capture personal identification information. For example, if an individual such as a sales prospect doesn't carry an identification badge or possesses a badge which cannot be read or contain conflicting or additional information, then a video image of the individual's personal identification, such as a business card or badge, can be recorded for that individual and associate with a corresponding record. Thereafter, additional lead information associated with that individual can be used in association with a record stored in the device.

Benefits of using a system and device according to the invention in the trade show industry include the ability to attract and retain exhibitors, provide up-to-date consumer demographics, provide improved database marketing, enable users to identify unique sponsorship opportunities, capture attendee leads electronically and provide earlier opportunities for follow-up activity, and thus attract more consumer interest. Analysis of data collected by such a method provides improved ability to direct future marketing, create new revenue streams, and facilitate the sharing of data among users of remote systems.

### BRIEF DESCRIPTION OF THE DRAWINGS

Preferred embodiments of the inventive devices are illustrated in the drawings and will be described below.

FIG. 1 illustrates a device for collecting sales lead information according to the invention.

FIG. 2 illustrates a system according to the invention comprising a network incorporating at least one of the devices exemplified in Figure one.

FIG. 3 illustrates a system according to the invention comprising a network incorporating at least one of the devices exemplified in Figure one.

FIG. 4 illustrates a system according to the invention comprising a network incorporating at least one of the devices exemplified in Figure one.

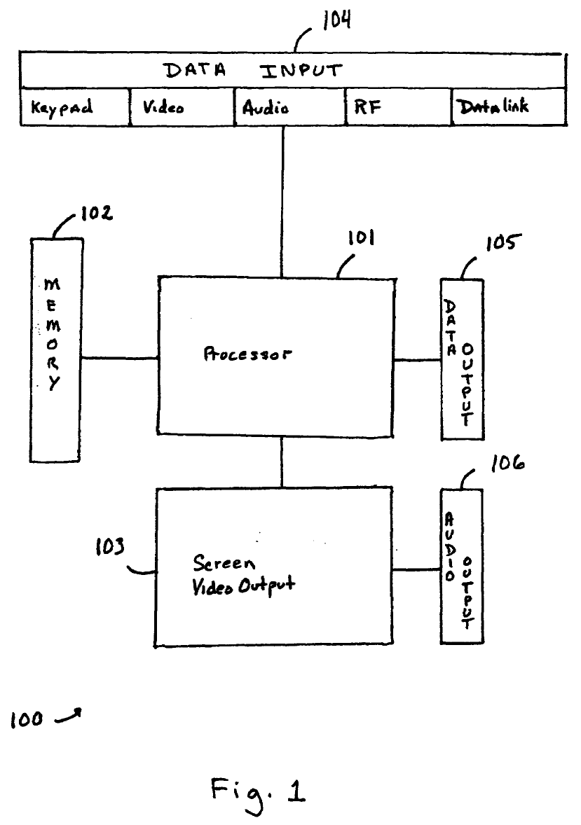

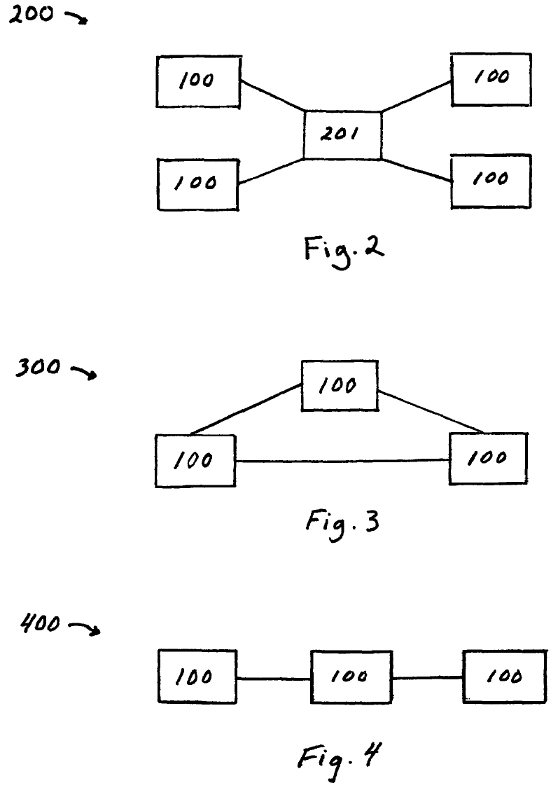

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION

A detailed description of the devices and methods for collecting lead information is provided below for general applicability. In addition, several specific embodiments are provided as examples of the devices and methods with which one of ordinary skill in the art may apply these teachings to address specific problems and to illustrate the benefits and improvements of the system and method over known solutions.

A contact collection device (100) for collecting sales lead information at a point of contact according to the invention is shown in Figure one. The contact collection device (100) includes a processor (101), a memory (102), a graphic display for video output (103), a data input (104), a data output (105), and an audio output (106). It can be appreciated by one ordinary skill in the art, that the processor (101), memory (102), and graphic display (103) can be programmed to provide the means for performing a number of the function described herein, and displaying the output results. It can be appreciated that embodiments of the contact collection device (100) include small hand-held devices, as well as terminals and central servers designed for use with hand-held collection devices.

It can be appreciated that the processor (101) and memory (102) can be programmed to perform the functions of the invention described herein. For example, a processor (101) provided with programming can be an integrated circuit used in conjunction with a memory (102), which memory comprises programming that the processor executes. It can also be appreciated that a processor (101) provided with programming can also be an integrated circuit hardwired to perform one or more functions of the invention described herein.

The data input (104) can provide an input port for data from a number of sources. Input data can be provided from a keypad, a video data source, and an audio data source, a data link among other things. Data can be transmitted to the data input (104) by means of a variety transmission media, such as a hard-wired data link, and a radio frequency transmission link among other things. The data input (104) can comprise one or more ports on a device according to the invention. For example, a separate input port can be provided for audio information coming from a device such as a microphone. In addition, a separate data link port, or port to a separate bar code or RFID scanner can be provided. In an alternative embodiment of the invention, one or more input ports (104) can be provided, and these ports can be connected to an additional device which can receive and combine information from one or more input ports to provide a single input port for communication with a single input source.

A contact collection device (100) can be used in conjunction with identification devices specifically designed for use with the invention, such as information badges, and/or with other information sources, such as generally used identification. Individual identification can be obtained from a variety of sources utilizing a number of known technologies, such as encoded magnetic strips, scan or bar codes, or devices that incorporate wireless and RFID technologies to transmit information.

Data input is preferably obtained from electronic or digital sources. For example, using “swiped” or scanned data from a sales lead badge, a system and device according to the invention can track sales lead information and services utilized at a exhibition event. In addition to scanning devices, such as barcode and magnetic-stripe, RFID, smart cards, and wireless and RFID transmission, are additional examples of input sources that can provide for automated capture and input of data to the contact collection device (100).

Preferably, the contact collection device (100) captures data from individual leads at a point of contact. Accordingly, the contact collection device (100) is preferably designed to suit the form of information input expected at a data collection event. For example, where information badges are used at an event location, the contact collection device (100) can be designed specifically for data input from such badges.

It can be appreciated by individuals of skill in the art that passive sources of information can provide information for receipt by the contact collection device (100) upon the initiation of a data capture process by the device. A device according to the invention comprises a capture process for receiving lead information during a contact. For example, RFID badges may be based on 13.56 Mhz frequency, to provide a reliable, passive tracking system. Badges are preferably passive devices, but active devices may also be used. A badge can be read from a distance of about 4 inches, making it suitable for tracking participants whose data is to be recorded. In addition badges provided at a trade exhibition can provide information encoded in a variety of formats: 1D and 2D bar code; magnetic stripe; RFID; and removable memory in the form of a USB stick, among other things.

Alternatively, information can be entered from other sources, such as a government issued identification. Entry of information into electronic form can be done prior to a sales lead contact, such as during a registration process at an event. Data can be input to a contact collection device, such as by keying the data through a keypad, or data can be transmitted electronically to the hand-held unit by another device, such as a registration terminal or another hand-held unit. Thus, devices and systems according to the invention can be specifically adapted to obtain personal identification information, such as a badge at a trade show or a government issued identification.

Individual information is stored in a memory (102) in the contact collection device (100). It can be appreciated that the information can be stored in a database on a floppy disk, on a USB memory stick, on a memory card or secure data card and/or a remote unit's battery-backed memory among other things. Information about a particular lead is preferably stored in a record that is uniquely identified to a particular lead. Lead information can be input during a point of contact, and can be downloaded to the contact collection device (100) from other hand-held devices or from a terminal or server containing lead information. The information includes personal identification information and other information regarding the lead such as demographic information or location information in an event, among other things. A user can record contemporaneous observation data about a lead, which can provide the basis for follow up activity and provide other survey information. Location information, such as an exhibition booth, identifying data collection points can be appended as an additional data field and/or created as a voice tag to facilitate identification.

An important aspect of the invention is the association of data that is input at a point of contact with a lead, with a unique data record associated with the lead. Where a lead record has been input into a contact collection device (100) at a point contact, such as by reading an identity badge, input of additional data such as a voice note or a video capture can be automatically associated with the lead record associated with the lead. For example, when identification information is obtained for an individual at a point of contact, the device can prompt a user to record observation data, which data can be automatically associated with the record containing the individual information. For example the prompt can be a field in the record which can indicate to a user that additional information, such as personal identification information or observation data, can be collected for the record.

The lead record stored in the memory (102) of a contact collection device (100) can be provided with a field that identifies the presence of additional video or audio information. It can be appreciated that a link can be automatically created based on the presence of a marker in a audio and/or video field to link information associated with the lead with audio and/or video information collected at a point of contact. Thus, it can be appreciated that the contact collection device (100) can use a predetermined scheme to identify point of contact information that is associated with a lead record stored in the device.

It can be appreciated that an embodiment of the invention can provide several ways to store captured observation data. Where a lead's information is collected and contained a unique record identifier, a marker can be provided in the record for that lead indicating the presence of one or more voice records. The unique record identifier can be a sequence number or generated based on the lead personal information. For example, the voice record can be provided with a file name associated with the unique record identifier, and be provided with a numeral appended to the file name indicating the order of recordation of the voice record. (e.g., 1_john_smith, or 1_{—}123456789). Thus, it can be appreciated that storage of data and linking of associated records can be done in a number of ways, such as storing voice and audio data in a dedicated sub-folder of a device's storage unit. Alternatively, or in addition observation data and other personal identification information can be sent to a remote center server, such as a network server, for processing.

Information stored on the device (100) can be shown to a user on the display (103). For example, the display (103) can show a list of records, information contained in one or more records, as well as image information captured as observation information. It can be appreciated that the display (103) can provide several pages of information associated with one or more record which a user can access such as by selecting a tab associated with a page of information.

In another embodiment of the invention, network accessibility is provided for uploading, downloading, accessing and sharing of lead information in a database stored in once contact collection device (100) with other contact collection devices (100), data input terminals, as well as network servers. In another embodiment, information can be captured by hand-held devices according to the invention and uploaded to an on-line database for access by a number of remote users of other contact collection devices (100). In addition, lead information can be exported from a network, such as a website, to a database format, such as a CSV or Excel file format which can be read by standard applications such as Excel, and can thereby be viewed remotely on hand-held contact collection devices (100) or other devices with internet access.

Data that is collected remotely can be stored initially on a remote unit and uploaded to a central database. In addition, all or some of a central database can be stored on each remote unit. Alternatively, a remote unit can access data from a central database upon demand. Access to a central database containing lead information also provides the ability of a central user to edit or supplement data, and to provide reports and special search queries. Providing a central database management allows remote users to focus on data collection and follow-up based upon data that has been collected. Users of a central database can provide for voice recognition of voice records input by hand-held devices, edit or supplement data, manage and sort the data, and resending the data for download by users of remote hand-held devices (100). The captured data can be used to automatically generate customized reports and can be integrated with other systems, such as case management systems.

Lead collection devices (100) can be programmed to provide for automated lead retrieval, data tracking, and management of lead data. For example, devices according to the invention can be employed by trade show exhibitors to record, qualify and manage sales leads. Providing database information management with associated video and audio data stored on a data collection device (100) provides for a quick and easy method of analyzing leads. For example, in the context of lead collection at an exhibition event it is useful for a user to easily and quickly sort and filter leads in the database by various criteria, and thereby facilitate follow-up activity at the event location. An important aspect of the invention, is the ability of users not only to capture observation data in the form of voice and video records associated with lead data, but to also to qualify lead information based upon point of contact information, among other things. For example, the device can provide for additional fields in a record to store qualification data, such as high, medium or low priority, which can be entered by a user immediately after a point of contact. Qualification of lead information facilitates a user's decision process for follow-up activity.

For example, where a lead collection device (100) contains a number of records containing lead information, in the records contain audio and/or video records, the device is programmed to permit the user to review the audio or video records in a predetermined sequence. Alternatively, the user can search for a record according to various criteria, such as an additional priority field, which can be used to sort records. In an alternative embodiment, a user can review records, and reorder a list or create a new list of lead records stored on the device in order to prioritize, and/or schedule follow-up. For example, thumbnail images of video and/or audio records in a list can be provided on the display (103) to facilitate identification of records, and reordering of a list of records by the user.

In another embodiment of the invention, devices can be employed with the coordinated use of video surveillance systems for input of data associated with an individual. Application of video surveillance with the invention includes, the prevention of theft, the monitor of leads or competitors who may visit an identification station, such as an exhibit when it is unattended, and to allow a remote or central office to observe activity. A motion detector can trigger a video surveillance system's record function, and can provide video or photographic data for association with an individual record.

In another embodiment, a device and system according to the invention can be provided for linear tracking of lead activity where individual information can be collected at several times and at several locations. For example, lead information can be initially entered at a check-in station, or a lead collection device (100). Thereafter, one or more addition lead collection devices (100) can be employed to enter additional information. For example, after check-in an individual may visit a first room and additional information, such as observation data associated with the individual's visit of the first room can be recorded by a user. Likewise, the individual may thereafter visit a second room and additional information, such as observation data associated with the individual's visit of the second room can also be recorded by a user.

Video and/or audio information can be associated with the individual information at check-in and/or at other data collection points thereafter, and the several lead collection devices (100) can coordinate the synchronized collection of lead information. For example, in a baggage handling application RFID can be used to identify a unit of baggage and collect additional information concerning the baggage at other locations.

Figure two illustrates the use of one or more lead collection devices (100) designed for use in a network having a centralized server (201). The centralized server (201) can provide for the collection and storage of lead information hand-held devices (100), and transmission of lead information to hand-held devices (100). For example, the centralized server (201) can be a terminal for input of lead information at check in, which can then be transmitted to remote hand-held units. Alternatively, or in addition, the centralized server (201) can be web site from which hand-held devices can download lead information.

Figure three illustrates the use of one or more lead collection devices (100) designed for use in a network, wherein a lead collection devices (100) can communicate with one or more other lead collection devices (100). A lead collection device (100) can transmit or receive lead information from one or more other lead collection devices (100).

Figure four illustrates the use of one or more lead collection devices (100) designed for use in a linear network, wherein a first lead collection device (100) can provide first lead information associated with a particular lead, and one or more additional lead collection devices (100) can provide additional lead collection information associated with the particular lead.

The invention has been described in connection with certain preferred embodiments. It will be appreciated that those skilled in the art can modify such embodiments without departing from the scope and spirit of the invention that is set forth in the appended claims. Accordingly, these descriptions are to be construed as illustrative only and are for the purpose of enabling those skilled in the art with the knowledge needed for carrying out the best mode of the invention. The exclusive use of all modifications and equivalents are reserved as covered by the present description and are felt to be within the scope of the appended claims.

We claim:

1. A method of collecting point of contact information, comprising:
obtaining personal identification information associated with at least one individual,
storing the personal identification information in at least one data record, obtaining observation data associated with the least one individual, storing the observation data, and
associating the observation data with the at least one data record, wherein the step of obtaining observation data includes obtaining audio information.

2. The method of collecting point of contact information according to claim 1, wherein the step of obtaining the personal identification information includes scanning information from an input device, wherein the input device is selected from a group of information sources comprising an RFID, a barcode and a magnetic strip.

3. The method of collecting point of contact information according to claim 1, further comprising playing back at least a portion of the audio information, and further comprising displaying at least a portion of the personal identification information.

4. The method of collecting point of contact information according to claim 1, wherein the step of obtaining observation data includes obtaining contemporaneous observation data including photographic information.

5. The method of collecting point of contact information according to claim 4, further comprising creating a thumbnail image associated with the personal identification information, and further comprising displaying at least a portion of the personal identification information with the thumbnail image.

6. The method of collecting point of contact information according to claim 1, wherein the step of storing the personal identification information in the at least one record includes storing the personal identification information in a database, and the step of associating the observation further comprises storing a data pointer to an observation record comprising observation data.

7. The method of collecting point of contact information according to claim 1, wherein the step of obtaining personal identification information further comprises a step of prompting a user to obtain observation data.

8. The method of collecting point of contact information according to claim 1, wherein the step obtaining observation data further comprises a step of prompting a user to obtain personal identification information.

9. The method of collecting point of contact information according to claim 1, further comprising sending and receiving network data in a network, wherein the network data includes at least a portion of the personal identification information.

10. A device for collecting point of contact information, comprising:
a data input, a processor, a memory, a user input, an audio output, and a display,
wherein the data input comprises a data link and an audio recorder, and
wherein the processor comprises programming to receive personal identification information associated with at least one individual from the data link, to store the personal identification information in the memory, to receive audio information associated with the at least one individual from the audio recorder, to store the audio information in the memory, to associate the audio information with the personal identification information, to display at least a portion of the personal identification information on the display, to output at least a portion of the audio information through the audio output, and to receive control commands from the user input.

11. The device for collecting point of contact information according to claim 10, wherein the data link comprises a scanner for reading personal data information from a barcode.

12. The device for collecting point of contact information according to claim 10, wherein the data link comprises a scanner for reading personal data information from an RFID.

13. The device for collecting point of contact information according to claim 10, wherein the processor is further programmed to store the personal identification information in the at least one record of a database, and further comprises storing a data pointer to a record comprising observation data, which observation data is associated with the at least one record.

14. The device for collecting point of contact information according to claim 13, wherein the processor is further programmed to receive control commands from a user to search for at least one requested record in the database, wherein the at least one requested record comprises at least a portion of the personal identification information, and to select the least one of the requested records for display of at least a portion of the personal identification information in the requested record, and for playback of at least a portion of the audio information associated with the requested record.

15. The device for collecting point of contact information according to claim 13, wherein the processor is further programmed to store user input data from the user input and to store the user input data in the at least one record, and wherein the user input data includes qualification information associated with the at least one record.

16. The device for collecting point of contact information according to claim 10,
wherein the data input further comprises a camera, and
wherein the processor further comprises programming to receive video data from the camera, to store the video data in the memory, to associate the video data with the personal information data, to display at least a portion of the personal information data and at least a portion of the video data on the display.

17. The device for collecting point of contact information according to claim 16, wherein the video data comprises at least one photo image, and wherein the processor further comprises programming to display at least one thumbnail image associated with the at least one photo image.

18. The device for collecting point of contact information according to claim 10, further comprising a network communication port for sending and receiving network data in a network, wherein the network data includes at least a portion of the personal identification information.

19. A system comprising a plurality of hand-held devices, wherein each of the plurality of hand-held devices comprises:
a data input; a processor; a memory; a user input; an audio output; a display;
wherein the data input comprises a data link and an audio recorder;
wherein the processor comprises programming to receive personal identification information associated with at least one individual from the data link, to store the personal identification information in the memory, to receive audio information associated with the at least one individual from the audio recorder, to store the audio information in the memory, to associate the audio information with the personal identification information, to display at least a portion of the personal identification information on the display, to output at least a portion of the audio information through the audio output, and to receive control commands from the user input;
a network communication port for sending network data to at least of the plurality of hand-held devices, and
a network communication port for receiving network data from at least of the plurality of hand-held devices,
wherein the network data includes at least a portion of the personal identification information.

20. A system comprising a network server and at least on hand-held device, wherein the at least one hand-held device comprises:
a data input; a processor; a memory; a user input; an audio output; a display;
wherein the data input comprises a data link and an audio recorder;
wherein the processor comprises programming to receive personal identification information associated with at least one individual from the data link, to store the personal identification information in the memory, to receive audio information associated with the at least one individual from the audio recorder, to store the audio information in the memory, to associate the audio information with the personal identification information, to display at least a portion of the personal identification information on the display, to output at least a portion of the audio information through the audio output, and to receive control commands from the user input;
a network communication port for sending network data to the network server, and
a network communication port for receiving network data from network server, wherein the network data includes at least a portion of the personal identification information.
